(19) United States
(12) Patent Application Publication
(10) Pub. No.: US 2022/0139041 A1
(43) Pub. Date: May 5, 2022

(54) REPRESENTATIONS IN ARTIFICIAL REALTY

(71) Applicant: Facebook Technologies, LLC, Menlo Park, CA (US)

(72) Inventors: Ziliu Li, Sammamish, WA (US); Gagneet Singh Mac, Pacifica, CA (US); Annika Rodrigues, Lynnwood, WA (US); Camila Cortes De Almeida E De Vincenzo, Seattle, WA (US); Cody Char, Seattle, WA (US); Yeliz Karadayi, Seattle, WA (US); Chris Rojas, Seattle, WA (US); Jenna Velez, Seattle, WA (US); Jenny Kam, Seattle, WA (US); Vaishali Parekh, San Francisco, CA (US); Aaron Draczynski, Seattle, WA (US); John Meurer, JR., Denver, CO (US); Jonathan Koehmstedt, Fort Myers, FL (US); Jiakang Lu, San Mateo, CA (US); Iurii Ashaiev, London (GB)

(21) Appl. No.: 17/578,940

(22) Filed: Jan. 19, 2022

Related U.S. Application Data
(60) Provisional application No. 63/236,336, filed on Aug. 24, 2021.
(60) Provisional application No. 63/219,532, filed on Jul. 8, 2021.
(60) Provisional application No. 63/212,156, filed on Jun. 18, 2021.
(60) Provisional application No. 63/176,840, filed on Apr. 19, 2021.
(60) Provisional application No. 63/160,661, filed on Mar. 12, 2021.

(51) Int. Cl. G06T 19/00; G06F 16/955

(52) U.S. Cl. CPC G06T 19/00; G06F 16/9558

(57) ABSTRACT

In some implementations, the disclosed systems and methods can automatically generate seller listing titles and descriptions for products; set a follow-me mode for various virtual objects, causing the virtual objects to be displayed as word-locked or body-locked in response to a current mode for the virtual objects and the location of the user of the XR device in relation to various anchor points for the virtual objects; create and/or apply XR profiles that specify one or more triggers for one or more effects that are applied to a user when the triggers are satisfied; and/or enable addition of external content in 3D applications.

### CROSS REFERENCE TO RELATED APPLICATIONS

This application claims priority to U.S. Provisional Application Nos. 63/160,661 filed Mar. 12, 2021, 63/176,840 filed Apr. 19, 2021, 63/212,156 filed Jun. 18, 2021, 63/219,532 filed Jul. 8, 2021, and 63/236,336 filed Aug. 24, 2021. Each patent application listed above is incorporated herein by reference in their entireties.

### BACKGROUND

Marketplace and ecommerce platforms give sellers the option to post listings of various products or services they want to sell to potential buyers. These listings typically include a title and description of the product or service being listed so that buyers can get a better sense of the characteristics or attributes of the product or service (e.g., color, device storage size, dimensions, etc.). Many systems provide sellers the option to manually input a title for the product or service, photos of the product or service, and/or a description of the product or service. For example, a seller may input a listing title “Phone Model A 2020 edition”, capture and upload an image of Phone Model A, and type a short description of “condition: used; color: black; device storage size: 128 GB; dimensions: 6 in-3 in-0.3 in”.

Artificial reality systems can display virtual objects in a variety of ways, such as by making them “world-locked” or “body locked.” World-locked virtual objects are positioned so as to appear stationary in the world, even when the user moves around in the artificial reality environment. Body-locked virtual objects are positioned relative to the user of the artificial reality system, so as to appear at the same position relative to the user's body, despite the user moving around the artificial reality environment.

People value expressing themselves in new and creative ways to connect with their community. This is evident in the physical world with clothing and fashion accessories, and in the digital world with selfies augmented with augmented reality (AR) effects. Such digital and physical artifacts enable people to showcase their unique identity and connect with others who have similar interests and tastes.

Artificial reality systems provide an artificial reality environment, allowing users the ability to experience different worlds, learn in new ways, and make better connections with others. Artificial reality systems can track user movements and translate them into interactions with “virtual objects” (i.e., computer-generated object representations appearing in a virtual environment.) For example, an artificial reality system can track a user's hands, translating a grab gesture as picking up a virtual object. A user can select, move, scale/resize, skew, rotate, change colors/textures/skins of, or apply any other imaginable action to a virtual object. There are also a multitude of systems that manage content external to an artificial reality environment, such as in webpages, geographical mapping systems, advertising systems, document processing systems, graphical design systems, etc. While some integrations between artificial reality systems and these external content sources are possible, they are traditionally difficult to manage and cumbersome to implement.

### SUMMARY

Aspects of the present disclosure are directed to an automated seller listing generation system. When sellers list products on a marketplace or ecommerce platform, it is often cumbersome for the seller to upload images and type in titles and lengthy descriptions manually. Furthermore, due to the various ways that a seller can title and describe the product, there are many different titles on marketplace platforms that describe the same product, making product categorization difficult. The automated seller listing generation system can automatically generate listing title and description suggestions for a product. A seller can upload a product's image, and the automated seller listing generation system can predict a product label and attributes for the product in the image. Based on the predictions, the automated seller listing generation system can use a hierarchical structure to suggest possible listing titles and descriptions for the product.

Artificial reality (XR) systems can provide new ways for users to connect and share content. In some XR systems, interactions with other users can be facilitated using avatars that represent the other users. For Example, an avatar can be a representation of another user that can be interacted with to start a live conversation, send a content item, share an emotion indicator, etc. As more specific examples, a user may select such an avatar to see set of controls for such actions, being able to select one to start a call, or a user may drop an item on such an avatar to share a version of that item with the user the avatar represents. In some cases, such an avatar can be controlled by the person it represents, e.g., either by moving or displaying content as directed by that user or by parroting the movements of that user. Some such avatars can have world-locked positions. However, such avatars can be awkward to use when the user wants to move away from the avatar's world-locked position. To address this, the avatars can be displayed by an XR device by default in a world-locked manner, allowing for easy interaction with the user represented by the avatar. However, when the user of the XR device moves away from the avatar's world-locked position, such as by moving to another room, the avatar can become body locked to the user. The avatar can stay in a body-locked mode until the user enters a location where there is a defined world-locked anchor for the avatar, at which point the avatar can moves to the new anchor location.

In various implementations, a seller can begin inputting a product listing, and the automated seller listing system can predict in real-time the next attribute type and value for the product listing. The automated seller listing generation system can subsequently suggest the predicted attribute value to the seller for autocompleting the product listing input.

Aspects of the present disclosure are directed to the creation and application of XR profiles. An XR profile can specify one or more triggers such as a location, audience, audience type, timeframe, other surrounding objects, user mood, conditions from third-party data (e.g., weather, traffic, nearby landmarks), etc. The XR profile can further specify one or more effects paired with the triggers that are applied when the triggers are satisfied. For example, the effects can modify an image (e.g., change a user expression), add an overlay (e.g., clothing, makeup, or accessories), add an expression construct (e.g., thought bubble, status indicator, quote or text), etc. In some cases, the XR profile can be applied across multiple platforms such as on social media, in video calls, live through an augmented reality or mixed reality device, etc.

Aspects of the present disclosure are directed to enabling external content in 3D applications by pre-establishing designated external content areas and, when users are in an artificial reality environment from the 3D application, selecting matching external content. 3D application controllers (e.g., developers, administrators, etc.) can designate areas in their 3D application in which 3D content can be placed. Such areas can be 2D panels or 3D volumes of various shapes and sizes. These areas can be configured with triggering conditions for when and how they will be displayed. Once established and when a corresponding triggering condition occurs, an external content system can select what content to add to these areas. In some implementations, a viewing user can select displayed external content to access related controls and/or additional information.

### BRIEF DESCRIPTION OF THE DRAWINGS

FIG. 1 is a block diagram illustrating components which, in some implementations, can be used in an automated seller listing generation system.

FIG. 2 is a block diagram illustrating components of a fusion model, which in some implementations, can be the fusion model in FIG. 1.

FIG. 3 is a conceptual diagram illustrating an example of a product hierarchy tree, which in some implementations, can be the product hierarchy tree in FIG. 2.

FIG. 4 is a conceptual diagram illustrating an example of a product description table for a leaf node in FIGS. 2 and 3.

FIG. 5 is a conceptual diagram illustrating an example of a user interface on the seller's computing device for displaying the suggested listing titles and descriptions.

FIGS. 6A-C are conceptual diagrams illustrating an example of a world-locked follow mode when a user of an XR system moves from an office room, to hallway, to bedroom.

FIGS. 7A-C are conceptual diagrams illustrating an example of body-locked mode when a user of an XR system moves from an office room, to a hallway, to a bedroom.

FIGS. 8A-8C are conceptual diagrams illustrating an example of a world-locked no-follow mode when a user of an XR system moves from an office room, to a hallway, to a bedroom.

FIGS. 9-13 are reserved.

FIG. 14 is a block diagram illustrating components which, in some implementations, can be used in an automated seller listing generation system.

FIG. 15 is a conceptual diagram illustrating an example of a product attribute graph.

FIGS. 16A-B are conceptual diagrams illustrating examples of predicting attribute types and values for product listing inputs.

FIG. 17 is an example of a user participating in a video call with an XR profile triggered for friends and providing an expression effect.

FIG. 18 is an example of a user having posted to a social media platform with a XR profile triggered for the public and providing a status effect.

FIG. 19 is an example of a user being viewed live with a XR profile triggered for specific users, providing an accessory effect.

FIG. 20 is an example of a user being viewed live with a XR profile triggered for a specific location, providing a networking card effect.

FIG. 21 is an example of users being viewed live with a XR profile triggered for a timeframe, providing a photobooth effect.

FIG. 22 is a flow diagram illustrating a process used in some implementations for creating an XR profile with one or more effects and one or more triggers.

FIG. 23 is a flow diagram illustrating a process used in some implementations for showing a user with effects specified by an XR profile when trigger conditions for the XR profile are met.

FIG. 24 is an example of an area being designated for external content in an artificial reality environment.

FIG. 25 is an example of a rectangular, 2D designated area with external content in an artificial reality environment as viewed by a viewing user.

FIG. 26 is an example of a cuboid 3D designated area with external content in an artificial reality environment, being selected by a user to show an external content menu.

FIG. 27 is an example of a browser in an artificial reality environment overlaid on a paused application showing content related to external content provide in the application.

FIG. 28 is a flow diagram illustrating a process used in some implementations for establishing an external content area in a 3D application.

FIG. 29 is a flow diagram illustrating a process used in some implementations for adding external content to an established area in a 3D application.

FIG. 30 is a block diagram illustrating an overview of devices on which some implementations of the disclosed technology can operate.

FIG. 31 is a block diagram illustrating an overview of an environment in which some implementations of the disclosed technology can operate.

### DESCRIPTION

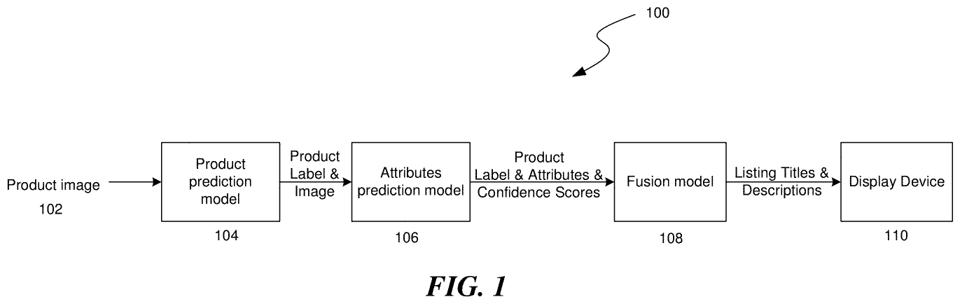

FIG. 1 is a block diagram illustrating components which, in some implementations, can be used in an automated seller listing generation system. Automated seller listing generation system 100 can first receive a product image 102 uploaded by a seller. Product prediction model 104 can then take as input product image 102 and output a product label for the product in product image 102 using a machine learning model. In other words, product prediction model 104 can predict a product label for a given product image in order to identify the product in the image. For example, product prediction model 104 can input an image of a pickup truck and output the product label “truck”. The machine learning model can be trained on image data comprising the product in the product image that is annotated with the product label (e.g., data records of the form {product image; product label}). Product prediction model 104 can also predict a confidence score (e.g., a probability value) representing the degree of confidence in the prediction of the product label for the product image.

Attributes prediction model 106 can take as input product image 102 and the product label as outputted from the product prediction model. Based on the product label and product image 102, attributes prediction model 106 can predict attributes (or characteristics) that describe the product using a machine learning model. For example, attributes prediction model 106 can input an image of jeans with a product label “jean pants” and output attributes such as: {color: navy blue, size: 31-30, brand: “generic brand name”, material: cotton 65%, polyester 35%}: In some implementations, attributes prediction model 106 can also predict confidence scores for the predicted attributes. Each confidence score can represent how confident attributes prediction model 106 is at predicting each attribute or the likelihood the attribute is correct (e.g., probability likelihoods). For example, attributes prediction model 106 can predict the following confidence scores for the attributes of a product labeled “jean pants”: {color: 95%, size: 70%, brand: 30%, material: 55%}. The machine learning model can be trained on image data comprising product images and labels that are annotated with attributes and corresponding confidence scores (e.g., data records of the form {product image, product label; attributes, confidence score}).

In some implementations, automated seller listing generation system 100 can select a different attributes prediction model depending on the product label. For example, attributes prediction model 106 for product labels of “novel” may predict attributes such as book title, author, book reviews, or storyline. On the other hand, attributes prediction model 106 for product labels of “car” may predict attributes such as brand, model number, make year, color, vehicle class, etc. In other implementations, attributes prediction model 106 can be a single machine learning model that predicts attributes for any product image. After determining a product label, attributes, and confidence scores for product image 102, fusion model 108 can take as input these predictions and output suggested listing titles and descriptions for the product. In other words, fusion model 108 can predict possible listing titles and descriptions based on the product label, attributes, and confidence scores. Display device 110 can then display the listing titles and descriptions as suggestions to the seller to select one of them as the title and description of the product.

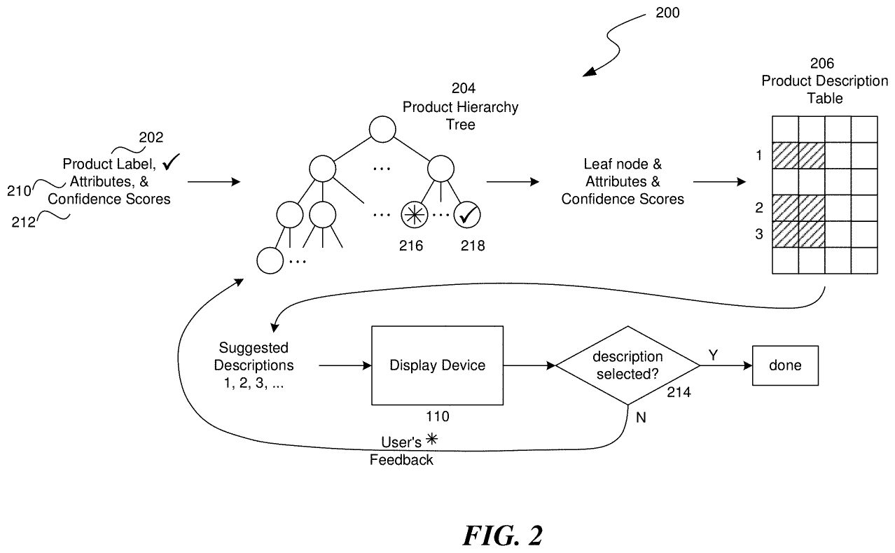

FIG. 2 is a block diagram illustrating components of a fusion model 200, which in some implementations, can be fusion model 108 in FIG. 1. Fusion model 200 can take as input product label 202, attributes 210, and confidence scores of 212 that are predicted by product prediction model 104 and attributes prediction model 106 of FIG. 1. Fusion model 100 is composed of product hierarchy tree 204 and product description table 206. Product hierarchy tree 204 can be composed of nodes that describe categories the products, with each depth of the tree containing nodes that are more refined categories of the product. Each parent node is a more general category with child nodes that are further refinements of the category of the parent node. Fusion model 200 can select the leaf node of product hierarchy tree 204 corresponding to product label 202. Each leaf node of product hierarchy tree 204 can have a corresponding product description table 206 that includes possible descriptions given the category of the leaf node. After selecting leaf node 218, fusion model 200 can obtain the corresponding product description table 206 for leaf node 218, and then match the product attributes 210 inputted to fusion model 200 to the rows of product description table 206 that contain elements with those attributes.

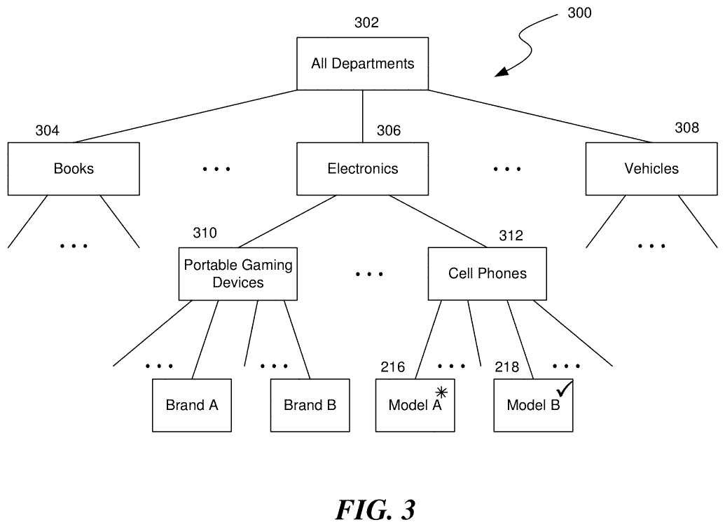

FIG. 3 is a conceptual diagram illustrating an example of a product hierarchy tree 300, which in some implementations, can be product hierarchy tree 204 in FIG. 2. The first layer of product hierarchy tree 300 can include node 302 for all departments, which can be the most general way of categorizing products. Node 302 for all departments can have child nodes including, but not limited to, node 304 for books, node 306 for electronics, node 308 for vehicles, etc. These nodes can describe specific departments of products, such as the book department, electronic department, and vehicle department for nodes 304, 306, and 308 respectfully. Each of these specific department nodes can have further child nodes describing general products in that specific department. For example, node 306 for electronics can have child nodes including, but not limited to, node 310 for portable gaming devices, node 312 for cell phones, etc. Each of the general product nodes can also have further child nodes describing specific models, brands, or makes of the general product. For example, node 312 for cell phones can have child nodes including, but not limited to, leaf node 216 for Model A, leaf node 218 for Model B, etc. The depth of the tree and the number of nodes can depend on the degree of specificity desired for the automated seller listing generation system and is not limited to the way nodes are categorized in FIG. 3. Based on the product label inputted into the fusion model, the automated seller listing generation system can select the leaf node (a node in the last layer of the tree) in the product hierarchy tree corresponding to the product label. For example, the product label can be Model B and the automated seller listing generation system can select leaf node 218 for Model B.

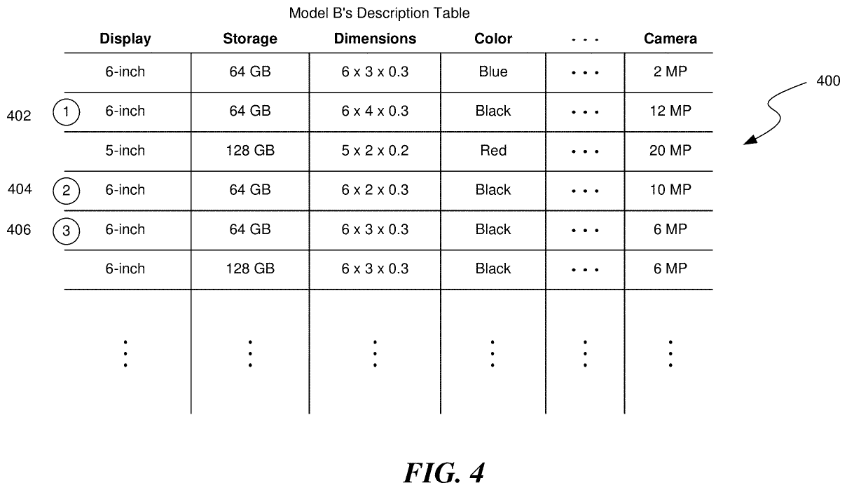

FIG. 4 is a conceptual diagram illustrating an example of a product description table 400 for leaf node 218 in FIGS. 2 and 3. In some implementations, product description table 400 can be product description table 206 in FIG. 2. The automated seller listing generation system can select rows of the product description table for Model B which include elements comprising the following attributes: display: 6-inch, storage: 64 GB, and color: black. These attributes can be attributes 210 with confidence score 212 for product label 202 of FIG. 2. In some implementations, only the attributes with confidence scores above a predefined threshold confidence value are used to match rows in product description table 400 with those attributes. The automated seller listing generation system can match rows 402, 404, and 406 that comprise the product attributes, and compose suggested titles and descriptions for each of the matched rows. For example, the automated seller listing generation system can compose the following title and description for row 402: “Model B: 6-inch display, 64 GB storage, 6×4×0.3 dimensions, black color, . . . , 12 MP camera.”

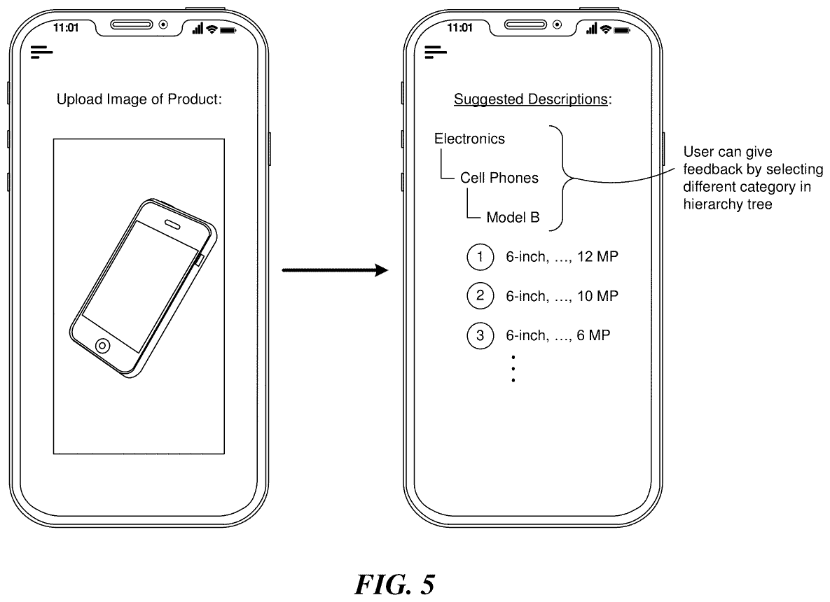

Returning to FIG. 2, once the suggested descriptions have been selected from the product description table 206, the automated seller listing generation system can then display the suggested listing titles and descriptions. In some implementations, the suggested listing titles and descriptions can be rows 402, 404, and 406 from product description table 400 in FIG. 4. The automated seller listing generation system can display the suggested listing titles and descriptions on display device 110 to the seller. FIG. 5 is a conceptual diagram illustrating an example of a user interface on the seller's computing device for displaying the suggested listing titles and descriptions. The automated seller listing generation system can then determine at block 214 whether the user has selected one of the suggested listing titles and descriptions. For example, the automated seller listing generation system can receive an indication that the user has pressed a suggested title and description listing on the user interface of display device 110. In response to determining the user has selected the suggested listing, the automated seller listing generation system can set the user's selection to be the product's actual listing title and description.

In some implementations, the automated seller listing generation system can receive feedback from the user that none of the suggested listing titles and descriptions are correct for the uploaded product image. For example, the automated seller listing generations can determine that the user has selected a different product category in the product hierarchy tree displayed in FIG. 5, manually entered a different product title or description, etc. In response to determining that user has not selected one of the suggested categories, titles, or descriptions, the automated seller listing generation system can determine in the product hierarchy tree the parent node that corresponds to the user-selected different product category. The automated seller listing generation system can then identify the leaf node that is a child of the user-selected parent node that corresponds to the product label with the next highest confidence score predicted by product prediction model 104. For example, the automated seller listing generation system can identify that “Model A” is the product label with the next highest confidence score after “Model B” (the previously suggested product), and in response select leaf node 216 of FIGS. 2 and 3. In some implementations, the automated seller listing generation system can input the new product label selected to attributes prediction model to predict new attributes. The new product label and attributes can then be inputted into the fusion model to determine a set of new listing titles and descriptions to present to the user based on the user's feedback.

Artificial reality (XR) interaction modes can implement a virtual object, such as an avatar, in a “follow-me” (follow the user) mode. Conventional XR systems typically require users to manually control and move virtual avatars or other virtual objects in an XR environment when a user moves around in a home, building, or other artificial reality environment. The follow-me mode can control avatars or other virtual objects spatially so that they automatically follow the user or lock-in to different locations as the user moves from room to room in a home or building. Accordingly, via the follow-me mode, the artificial reality interaction modes can provide users a greater access to their virtual objects, allowing them to interact with avatars or other virtual objects as the move from room to room.

In some implementations, the follow-me mode can include three different sub-modes: (1) a world-locked follow mode, (2) a body-locked mode, and (3) a world-locked no-follow mode. A virtual object in the world-locked follow mode can have defined world-locked anchor points. When a user is within a threshold distance or in the same room as such an anchor, the virtual object can be positioned at that anchor. However, when the user is not within the threshold distance or is not within the same room as the anchor, the virtual object can become body locked. A virtual object in the body-locked mode says body locked to the user as the user moves around. A virtual object in the world-locked no-follow mode can determine which anchor defined for a virtual object the user is closest to, and have the virtual object appear there. In some cases, if there is no anchor for the virtual object in the same room as the user or not within a threshold distance, the virtual object can be hidden.

The follow-me mode can understand the spatial layout of the house, determine where the user is spatially in the house, and control the position of an avatar or other virtual object based on which sub-mode is enabled or configured for that virtual object. In various implementations, the follow-me mode can be enabled for a particular avatar or other virtual object manually by a user, or based on various triggers such as when the user last interacted with the virtual object, a type of the virtual object, an identified relationship between the user and the virtual object, or a status of the virtual object. For Example, if the virtual object is an avatar and the user is currently engaging in a call with the user represented by the avatar, the avatar can automatically be placed in a follow-me mode. As another example, all objects of “avatar” type where a social graph dictates that the user and the user the avatar represents are connected as friends, then the avatar can automatically be in a follow-me mode. As yet a further example, a virtual object tied to particular output, such as a controller for music being played or a video panel can automatically be put in the follow-me mode.

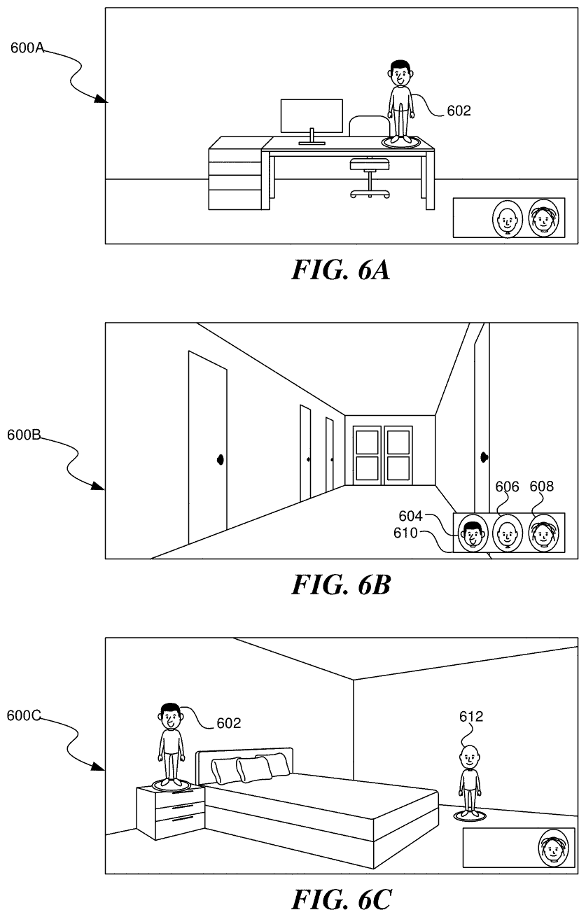

FIGS. 6A-C are conceptual diagrams illustrating an example of the world-locked follow mode when the user of the XR system moves from office room 600A, to hallway 600B, to bedroom 600C. Virtual object 602 can be a virtual avatar, which can be an animated representation of a remote person that the user is in communication with (e.g., audio/video calling, messaging, etc.) For example, virtual object 602 can be an avatar of a co-worker or an avatar of a friend. When virtual object 602 is an avatar, the avatar can move and change the facial expression or body language thereof to emulate the emotional state of the person represented. Virtual object 602 can also be an application (e.g., music/audio player, video player, media content, file sharing application, web browser, cloud service), a video or audio call with other users, a video game, an ambient notification (e.g., message notification, email notification, call notification, application notification), or any other virtual object. In various implementations, virtual object 602 can be a group of virtual objects that the user can interact with. In some implementations, the virtual object 602 can have user-defined, world-locked anchor points or system defined anchor points, e.g., based on a mapping of augment types to surface types and a ranking algorithm that selects anchor points on detected surfaces that match an allowed surface type.

When the user enters office room 600A, the world-locked follow mode can lock or anchor virtual object 602 to a defined anchor point in that room. If there are multiple anchor points in the room the system can select the one closest to the user. In some implementations, for an anchor point to be available, it must be within a threshold distance of the user, e.g., two or three meters. In this case, the selected anchor point is on a desk where the user previously placed the avatar, causing the avatar 602 to appear on the desk.

When the user leaves office room 600A, for example by entering the hallway 600B, the world-locked follow mode can release virtual object 602 from the locked position in office room 600A. The world-locked follow mode can subsequently cause a representation 604, of the avatar 602, to become locked to the body of the user, e.g., in avatar panel 610. Thus, a version of the avatar 602 follows the user around as he/she moves around the house or building. Accordingly, when the user enters hallway 600B, the world-locked follow mode can cause virtual object 602 to be presented in the avatar panel alongside other avatar representations 606 and 608, allocated to the avatar panel 610. The user can continue to interact with these avatar via their representations in the avatar panel.

When the user enters bedroom 600C from hallway 600B, the world-locked follow mode can determine that the avatars corresponding to representations 604 and 606 have anchors in bedroom 600C. The world-locked follow mode can remove representations 604 and 606 from the avatar panel and can cause the avatars 602 and 612 to be displayed as world-locked, at their anchor points (on the bedside table and at the foot of the bed).

In some implementations, the world-locked follow mode can adjust the settings of virtual object 602 depending on the room type. For example, when virtual object 602 is a music player, the world-locked follow mode can adjust the volume of the audio being played depending on the room the user is in. When the user is in hallway 600B, the world-locked follow mode can lower or mute the volume of the music player virtual object 602 to be cognizant of other individuals in the room or building. Conversely, when the user is in bedroom 600C, the world-locked follow mode can increase the volume of the music player virtual object 602.

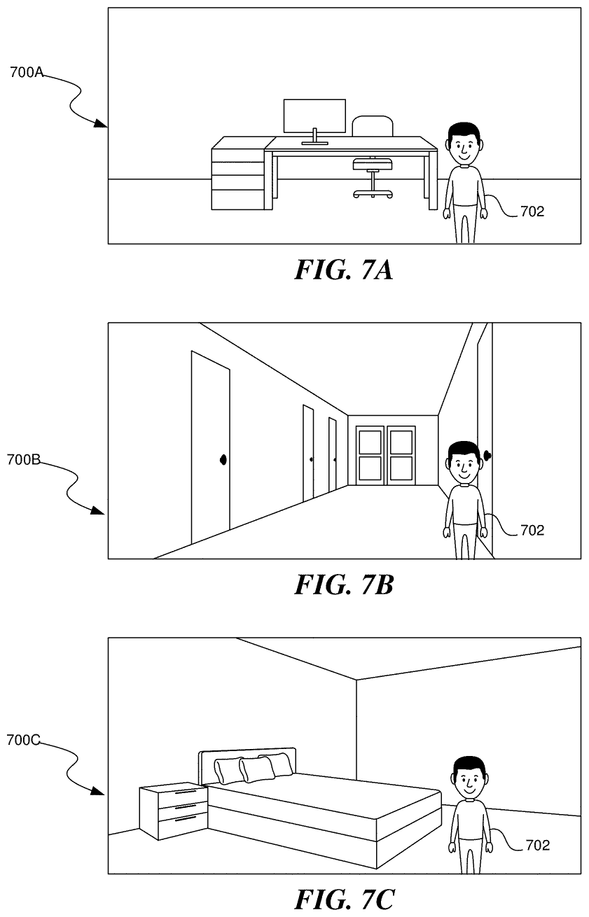

FIGS. 7A-C are conceptual diagrams illustrating an example of body-locked mode when the user of the XR system moves from office room 700A, to hallway 700B, to bedroom 700C. Virtual object 702 can be any virtual object, and in this case is an avatar 702. As the user moves about office room 700A, body-locked mode can keep avatar 702 body-locked, or anchored to the body of the user, so that avatar 702 stays with the user regardless of where the user is. This body-locked positioning continues when the user leaves office room 700A, the body-locked mode can keep avatar 702 anchored to the body of the user so that avatar 702 follows the user around as he/she moves around the house or building. Accordingly, when the user enters hallway 700B, the body-locked mode can cause avatar 702 to be presented alongside the user so that the user can interact with avatar 702 as he/she moves. Similarly, when the user enters bedroom 700C from hallway 700B, the body-locked mode can keep avatar 702 locked or anchored to the body of the user.

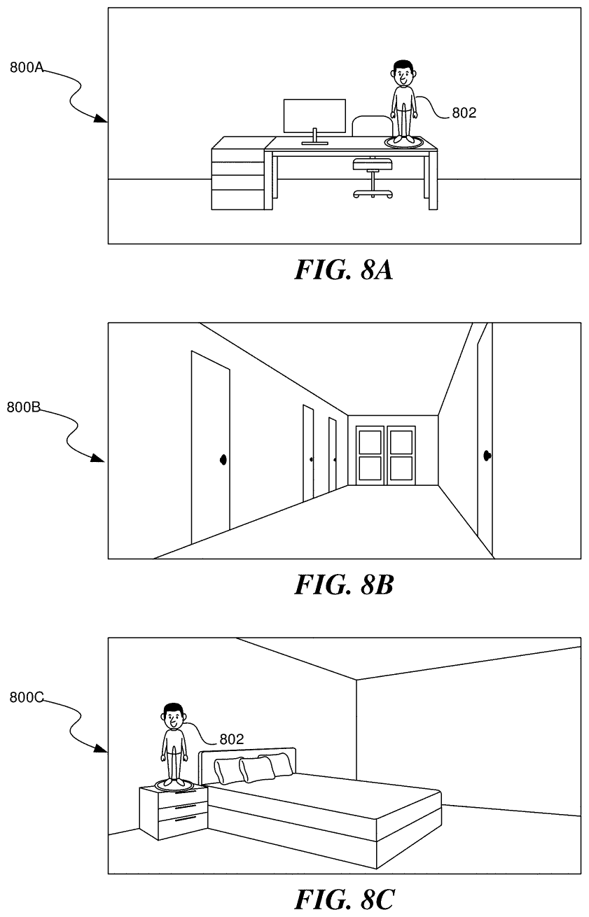

FIGS. 8A-8C are conceptual diagrams illustrating an example of the world-locked no-follow mode when the user of XR system moves from office room 800A, to hallway 800B, to bedroom 800C. Virtual object 802 can be any virtual object, and in this instance is an avatar 802. When the user enters office room 800A, the world-locked no-follow mode can identify an established anchor point for avatar 802, which is on the desk, causing avatar 802 to be displayed at that anchor point. When the user leaves office room 800A, the world-locked no-follow mode can keep avatar 802 locked in its current position in office room 800A (which can include no longer displaying avatar 802 when the user is a threshold distance from the anchor point or when the anchor points is no longer in view). Accordingly, when the user enters hallway 800B, the world-locked no-follow mode can cause avatar 802 to not follow the user as he/she moves to another room. Hence, avatar 802 is not displayed when the user is in hallway 800B. When the user enters bedroom 800C from hallway 800B, the world-locked no-follow mode can identify that the user is now in another room with a defined anchor point for the avatar 802, on the bedside table, causing the avatar 802 to be displayed in bedroom 800C at the anchor point on the bedside table.

In some implementations, the world-locked no-follow mode can present to the user a different version of avatar 802 or can adjust the settings of avatar 802 depending on the room type. For example, avatar 802 to be a live, parroted version of the represented user in office room 800A while it can be an inanimate representation in bedroom 800C.

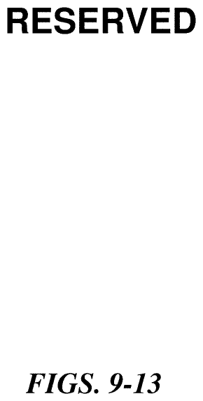

FIGS. 9-13 are reserved.

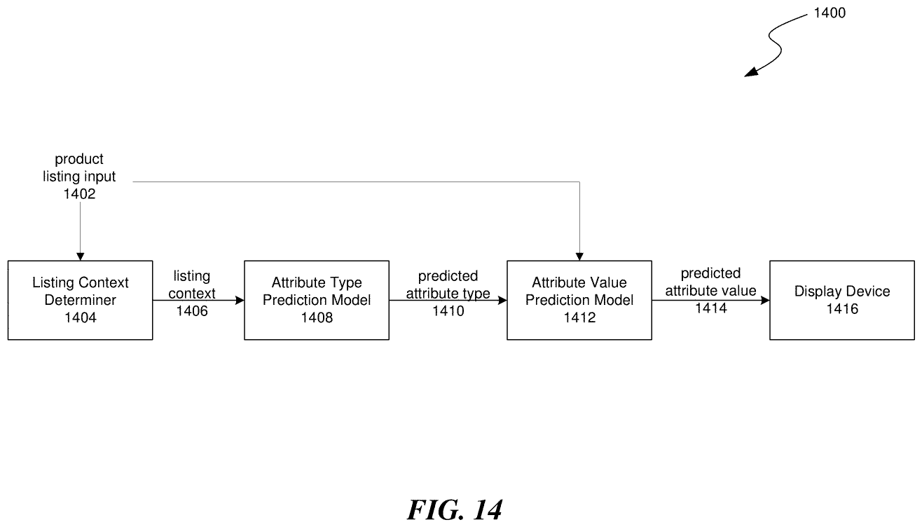

FIG. 14 is a block diagram illustrating components which, in some implementations, can be used in an automated seller listing generation system 1400. Automated seller listing generating system 1400 can first receive product listing input 1402 from a computing device (e.g., computer, mobile device, tablet, VR/AR headset) of a seller. Product listing input 1402 can be a listing tile and description currently being inputted to the computing device by the seller to share, e.g., on an online marketplace. The listing title and description can include text related to the characteristics or attributes of the product the seller would like to sell. Product listing input 1402 can be a partial and prefix title and description (e.g., some attributes of the product already inputted, some attributes of the product not inputted yet, no full attributes typed yet), meaning that the seller is concurrently inputting the listing. For example, product listing input 1402 can be “Car Brand EFG miniv”, which is a prefix for the seller's intended input of “Car Brand EFG minivan 7-seater all-wheel drive.”

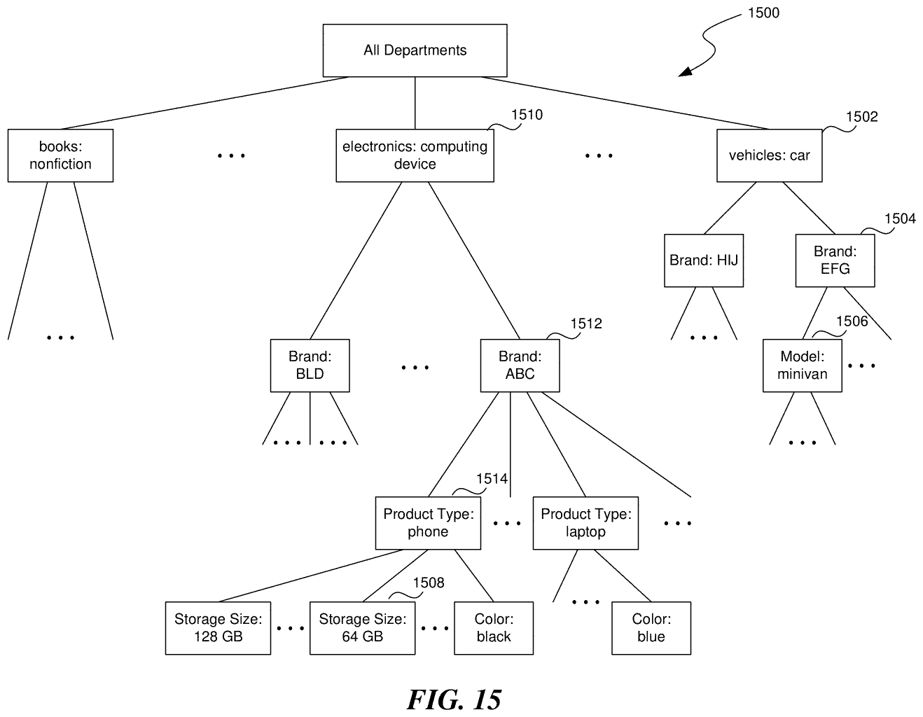

Listing context determiner 1404 can take receive/obtain product listing input 1402 and generate listing context 1406. Listing context determiner 1404 can first determine the context of product listing input 1402. In some implementations, the context can include local context. The local context can include product listing input 1402 and the current attribute types and values of product listing input 1402. Listing context determiner 1404 can determine the current attribute types and values of product listing input 1402 by matching the text of product listing input 1402 with predefined attribute types and values stored in a product attribute graph, such as product attribute graph 1500 in FIG. 15. The attribute types can be characteristic types of product listing input 1402, while the attribute values can be the characteristics themselves of product listing input 1402. For example, listing context determiner 1404 can determine the current attribute types to be “vehicle” and “brand,” while the current attribute values to be “car” and “Brand EFG” for listing input “Car Brand EFG miniv” from product attribute graph 1500.

The local context can further include a particular node of product attribute graph 1500 that product listing input 1402 corresponds to. Listing context determiner 1404 can identify the corresponding particular node by traversing product attribute graph 1500 based on product listing input 1402. For example, listing context determiner 1404 can traverse from node 1502 to node 1504 to node 1506, and then select node 1506 as the particular node for product listing input 1402 if product listing input 1402 is “Car Brand EFG minivan” Accordingly, listing context determiner 1404 can include node 1506 as part of local context. In some implementations, listing context determiner 1404 can further include neighboring nodes of node 1506 (e.g., nodes 1502 and 1504) that are within some threshold number of edges (e.g., 2 edges) away in product attribute graph 1500 as part of local context as well.

In some implementations, the context can further include a global context. The global context can include seller signals, such as previous seller product listing information and data. In some implementations, listing context determiner 1404 can construct a feature vector for listing context 1406 using the local context and/or global context. In other words, listing context 1406 can be an encoding, embedding, or any vectorized representation of the local and global context of product listing input 1402.

Attribute type prediction model 1408 can receive/obtain listing context 1406 and generate predicted attribute type 1410. Predicted attribute type 1410 can be a prediction for the next attribute type of product listing input 1402. In other words, predicted attribute type 1410 can be a prediction for what the attribute type is for the next attribute the seller will input for the product listing. For example, attribute type prediction model 1408 can predict “vehicle model” for the listing input “Car Brand EFG miniv”. To generate predicted attribute type 1410, attribute type prediction model 1408 can be a machine learning model trained to predict attribute type 1410 based on listing context 1406. The machine learning model can be one of various types of modes such as a graph neural network, deep neural network, recurrent neural network, convolutional neural network, ensemble method, cascade model, support vector machine, decision tree, random forest, logistic regression, linear regression, genetic algorithm, evolutionary algorithm, or any combination thereof. The machine learning model can be trained on datasets of labeled listing context and attribute type pairs (e.g., {listing context, attribute type}). The labeled and predicted attribute types can come from existing product listings, e.g., in nodes of product attribute graph 1500. Attribute type prediction model 1408 can predict a probability value for each node of product attribute graph 1500, which can each represent the likelihood that the attribute type associated with the node is predicted attribute type 1410. Attribute type prediction model 1408 can output the attribute type for the node with the highest predicted probability as predicted attribute type 1410.

Since listing context 1406 can include the particular node corresponding to product listing input 1402, attribute type prediction model 1408 may have knowledge regarding where the particular node is in the hierarchy of product attribute graph 1500. Accordingly, attribute type prediction model 1408 can learn, via model training, to assign higher probability values to child nodes or neighboring nodes of the particular node since they are more likely to be the predicted attribute type. Neighboring nodes or child nodes can be more likely to be part of the same input listing title and description. Since listing context 1406 can also include seller signals regarding previous product listing titles and descriptions from the seller, attribute type prediction model 1408 may also have knowledge regarding how the seller likes to input listing titles and descriptions. Accordingly, attribute type prediction model 1408 can learn, via model training, to assign higher probability values to nodes of product attribute graph 1500 with attributes that are more similar to the attributes of previous product listing titles and descriptions from the seller.

Attribute value prediction model 1412 can receive/obtain predicted attribute type 1410 and product listing input 1402, and then generate predicted attribute value 1414. Predicted attribute value 1414 can be a prediction for what the next attribute the seller wants to input for the product listing based on what has already been inputted by the seller (product listing input 1402) and the predicted attribute type 1410. For example, attribute value prediction model 1412 can predict “minivan” for the listing input “Car Brand EFG miniv” and the predicted attribute type “vehicle model”. To generate predicted attribute value 1414, attribute type prediction model 512 can be a language model (e.g., n-gram model) trained to predict attribute values 1414 based on product listing input 1402 and predicted attribute type 1410. Trained on product listing input 1402, attribute type prediction model 512 can examine the finer granularity syntax and local semantics of product listing input 1402 to determine what the next most likely character, word, or phrase the seller will input as part of the attribute value. Trained on predicted attribute type 1410 as well, attribute type prediction model 512 can use predicted attribute type 1410 to narrow down the possibilities/candidates for the next most likely attribute value the seller will input. The language model can be trained on datasets of labeled attribute type, listing input, and attribute value tuples (e.g., {attribute type, listing input; attribute value}). The labeled and predicted attribute values can come from existing product listings. Attribute value prediction model 1412 can boost the probabilities of nodes with attribute values more likely to be predicted attribute value 1414, while lowering the probabilities of nodes with attribute values less likely to be predicted attribute value 1414. Attribute value prediction model 1412 can then select the attribute value of the node with the highest probability as predicted attribute value 1414. In some implementations, attribute value prediction model 1412 can select a set of possible attribute values as predicted attribute value 1414. The set of possible attribute values can correspond to nodes having predicted probabilities of being the next attribute value the seller will input above a predefined threshold.

Display device 1416 (e.g., display of a computing device, mobile device, VR/AR device) can receive/obtain predicted attribute value 1414 and display predicted attribute value 1414 to the seller. In some implementations, display device 1416 can display predicted attribute value 1414 in the form of autocompleting product listing input 1402 in a GUI.

FIG. 15 is a conceptual diagram illustrating an example of a product attribute graph 1500. Product attribute graph 1500 can be a directed graph (hierarchical structure) or undirected graph. The nodes of product attribute graph 1500 can each be labeled with an attribute type and a corresponding attribute value. Product attribute graph 1500 can be structured in a way such that the closer the nodes are to one another (meaning fewer edges separating between them) the more likely the nodes are part of the same listing title and description inputted by the seller. When product attribute graph 1500 is a directed graph having hierarchical structure, child nodes can have finer granularity attribute types and values as compared to those of parent nodes. In other words, the attributes of child nodes can be more specific descriptors for a product described by the attributes of parent nodes. For example, node 1508 can describe “computing device ABC phone 64 GB”, in which “computing device,” “ABC,” and “phone” are attributes of nodes 1510, 1512, and 1514 respectively, which are parent nodes of child node 1508.

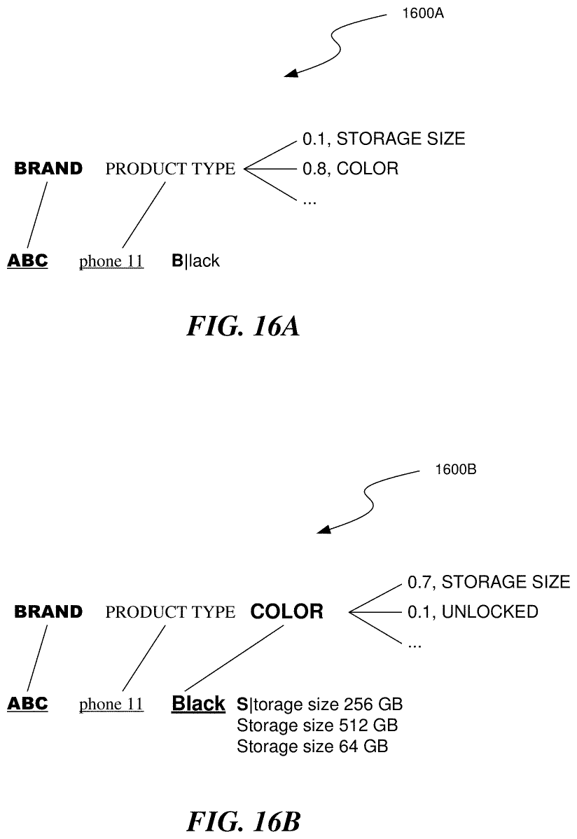

FIGS. 16A-B are conceptual diagrams illustrating examples 1600A and 1600B of predicting attribute types and values for product listing inputs. In example 1600A, the seller listing input “ABC phone 11 B” can be product listing input 1402 of FIG. 14. Listing context determiner 1404 can determine listing context 1406 of listing input “ABC phone 11 B.” Local context of listing context 1406 can include current attribute types “Brand” and “Product type” and their corresponding nodes in product attribute graph 1500, current attribute values “ABC” and “phone 11” and their corresponding nodes in product attribute graph 1500, and/or product listing input “ABC phone 11 B” itself. Global context of listing context 1406 can include, e.g., previous seller product listings of phone 11, historical seller product listings of ABC branded products, and other seller signals. Attribute type prediction model 1408 can predict attribute type 1410 based on listing context 1406. Attribute type prediction model 1408 can predict probabilities 0.1, 0.8, and so on for potential attribute types “Storage Size”, “Color”, and other unshown potential attribute types in example 1600A respectively. The predicted probabilities can represent the likelihood the potential attribute type is the actual attribute type of the inputted prefix “B”, which is part of the attribute the seller wants to input. Attribute type prediction model 1408 can output the potential attribute type “Color”, with the highest predicted probability of 0.8, to be predicted attribute type 1410.

In example 1600A, attribute value prediction model 1412 can predict attribute value 1414 based on predicted attribute type “Color” and listing input “ABC phone 11 B”. In some implementations, attribute value prediction model 1412 can output the potential attribute value “Black”, with the highest predicted probability, to be predicted attribute value 1414. The language model of attribute type prediction model 1408 can boost the probability of potential attribute value “Black” since “Black” has the prefix “B” like the partially inputted attribute “B” of listing input “ABC phone 11 B” and because the attribute type of “Black” is “Color”. Display device 1416 can display predicted attribute value 1414 as possible autocomplete suggestion: “Black”.

In example 1600B, the seller listing input “ABC phone 11 Black S” can be product listing input 1402 after the seller has selected the predicted attribute value suggestion of “Black” from example 1600A and began typing “S” as part of the next attribute the seller wants to input. Listing context determiner 1404 can determine listing context 1406 of product listing input “ABC phone 11 Black S.” Local context of listing context 1406 can include current attribute types “Brand”, “Product type”, “Color” and their corresponding nodes in product attribute graph 1500, current attribute values “ABC”, “phone 11”, “Black” and their corresponding nodes in product attribute graph 1500, and/or product listing input “ABC phone 11 Black S” itself. Global context of listing context 1406 can include, e.g., previous seller product listings of black colored phone 11s, historical seller product listings of ABC branded products, and other seller signals. Attribute type prediction model 1408 can predict attribute type 1410 based on listing context 1406. Attribute type prediction model 1408 can predict probabilities 0.7, 0.1, and so on for potential attribute types “Storage Size”, “Unlocked”, and other unshown potential attribute types in example 1600B respectively. The predicted probabilities can represent the likelihood the potential attribute type is the actual attribute type of the inputted prefix “S”, which is part of the attribute the seller wants to input. Attribute type prediction model 1408 can output the potential attribute type “Storage Size”, with the highest predicted probability of 0.7, to be predicted attribute type 1410.

In example 1600B, attribute value prediction model 1412 can predict attribute value 1414 based on predicted attribute type “Storage Size” and listing input “ABC phone 11, Black S”. In some implementations, attribute type prediction model 1408 can output the potential attribute values “Storage size 256 GB”, “Storage size 512 GB”, and “Storage size 64 GB” with the highest predicted probabilities, to be predicted attribute value 1414. The language model of attribute type prediction model 1408 can boost the probability of potential attribute values that start with “Storage Size” since they start with the prefix “S” like the partially inputted attribute “S” of listing input “ABC phone 11 S” and are of attribute type “Storage Size”. Display device 1416 can display predicted attribute value 1414 as a list of possible autocomplete suggestions: “Storage size 256 GB”, “Storage size 512 GB”, and “Storage size 64 GB,” from which the user can select.

An XR profile system can enable users to create XR profiles that specify triggers for activating certain effects when the user are seen through a variety of platforms such as on social media, in video calls, live through an augmented reality or mixed reality device, in an image gallery, in a contacts list, etc. The XR profile system enables users to create, customize, and choose content and other effects they want to be seen with in different contexts, while maintaining privacy controls to decide the location, duration, and audience that views the user with the effects content. The effects can be any computer-generated content or modification to the image of the user, such as to distort portions of an image, add an overlay, add an expression construct, etc. In various implementations, effects can include “outfits” where a user can choose from face or body anchored clothing, makeup, or accessory overlays; “statuses” where a user can specify a text, video, or audio message to output in spatial relation to the user; “expressions” where the user can set thought bubbles, animations, or other expressive content in spatial relation to the user; “networking” cards where a user can set information about themselves such as name, business, brand identifier, etc., that hover in spatial relation to the user; or a “photobooth” template where effects can be defined and shared with multiple other users to have a group effect applied to the group of users.

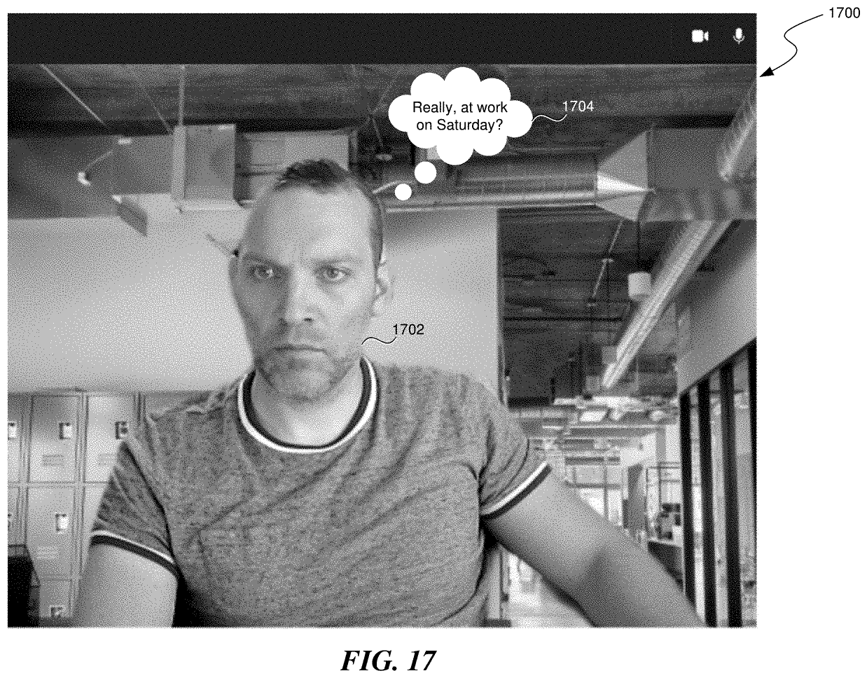

FIG. 17 is an example 1700 of a user 1702 participating in a video call with an XR profile triggered for friends and providing an expression effect 1704. In example 1700, the user 1702 has defined an XR profile with a trigger that is satisfied only when viewed by people designated on a social graph as the user 1702's friends. Thus, example 1700 is a view of a participant on the video call who has been designated on the social graph as user 1702's friend, and thus triggers the XR profile showing expression effect 1704—the thought bubble “Really, at work on Saturday?”

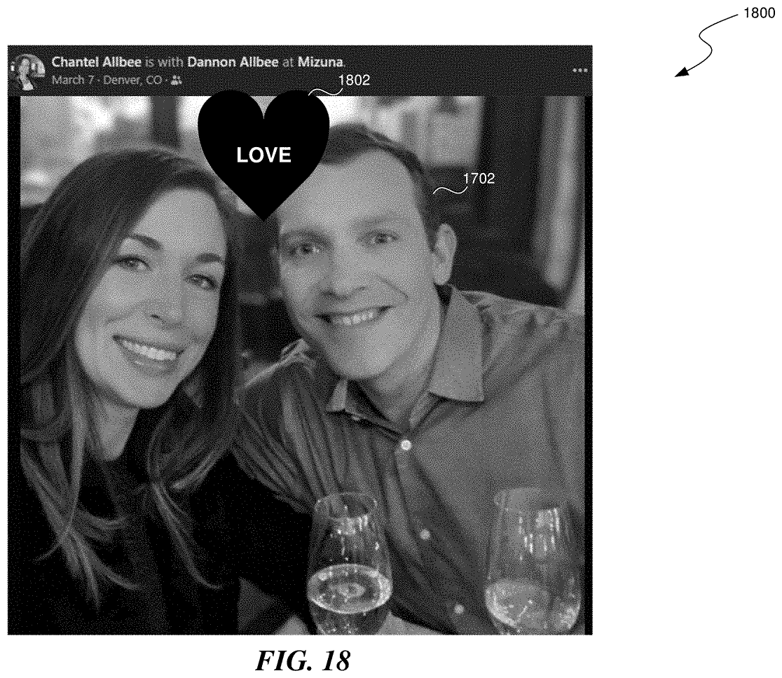

FIG. 18 is an example 1800 of the user 1702 having posted to a social media platform with a XR profile triggered for the public and providing a status effect 1802. In example 1800, the user 1702 has defined an XR profile with a trigger that is satisfied for the public on social media—e.g., all viewers through a social media platform. Thus, example 1800 is a view of a social media platform user, viewing the image of the user 1702 in a social media post, thus triggering the XR profile showing status effect 1802—a canned “Love” heart.

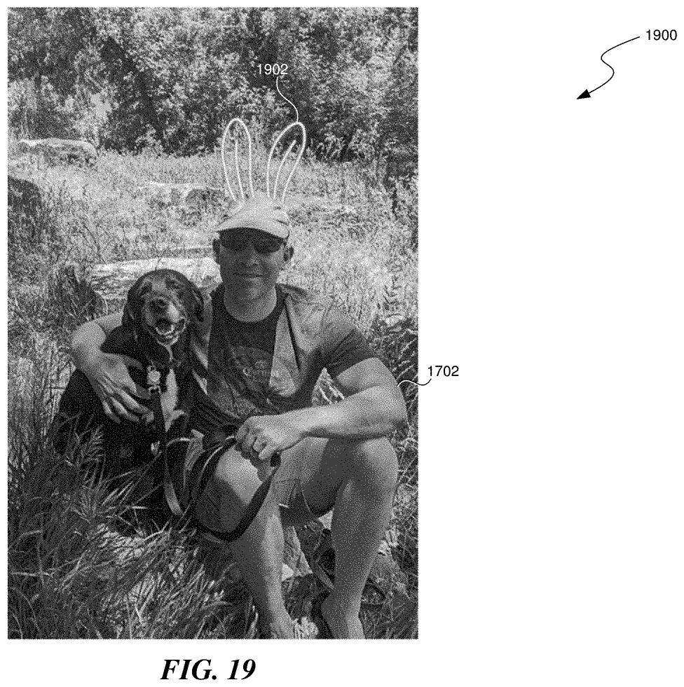

FIG. 19 is an example 1900 of a user 1702 being viewed live with a XR profile triggered for specific users, providing an accessory effect 1902. In example 1900, the user 1702 has defined an XR profile with a trigger that is satisfied when only a particular selected user is viewing user 1702. Thus, example 1900 is a viewpoint of the particular selected user, while wearing an MR device, and looking at the user 1702, thus triggering the XR profile showing the bunny ear accessory effect 1902.

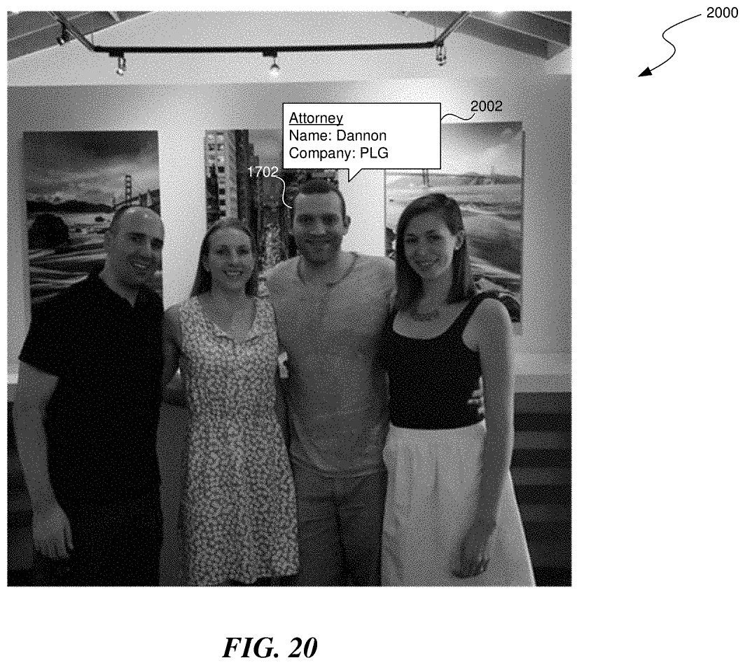

FIG. 20 is an example 2000 of a user 1702 being viewed live with a XR profile triggered for a specific location, providing a networking card effect 2002. In example 2000, the user 1702 has defined an XR profile with a trigger that is satisfied when the viewer of the image is within a defined geo-fence of a networking event attended by the user 1702. Thus, example 2000 is a viewpoint of a user within the geo-fenced area, while looking through an AR device at the user 1702, thus triggering the XR profile showing the networking effect 2002—with name and business information for the user 1702.

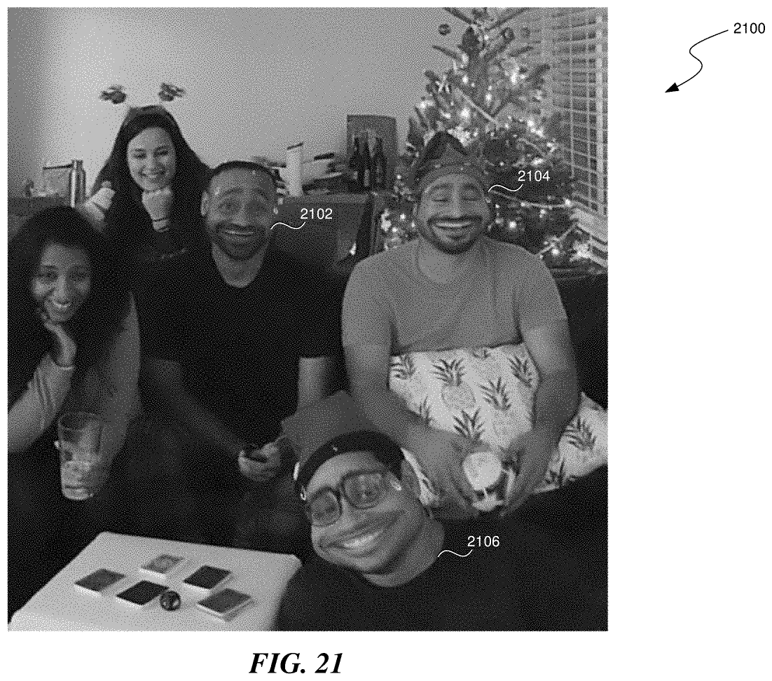

FIG. 21 is an example 2100 of users 2102-2106 being viewed live with a XR profile triggered for a timeframe, providing a photobooth effect. In example 2100, the user 2102 has defined an XR profile with a trigger that is satisfied during a particular timeframe of Dec. 25, 2021. The user 2102 has shared this XR profile with users 2104 and 2106, who have accepted it. Thus, example 2100 is a viewpoint a user, while wearing an MR device, and looking at the users 2102-2106 on Dec. 25, 2021, thus triggering the XR profiles showing the wide face photobooth effect on each of the users 2102-2106.

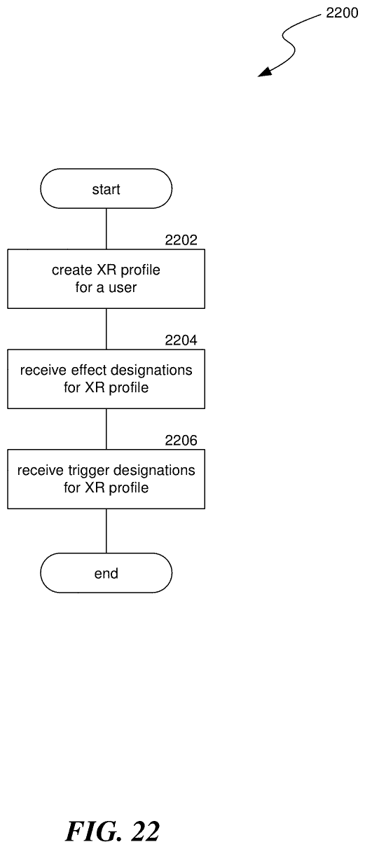

FIG. 22 is a flow diagram illustrating a process 2200 used in some implementations for creating an XR profile with one or more effects and one or more triggers. In various implementations, process 2200 can be performed on a user device or on a server system receiving commands from a user device. Process 2200 can be initiated by a user issuing an XR profile creation command, e.g., by activating an application or widget.

At block 2202, process 2200 can create an XR profile for a user. In some implementations, an XR profile can be automatically populated with some default triggers and/or effects based on the user's profile settings or social media data. For example, the user can set a default for XR profiles to be for users that are friend or friends of friends on a social graph. As another example, the user may have set values in a social media profile such as her birthday, which can automatically populate an XR profile on the user's birthday with a timeframe of that day and an effect of showing a birthday crown accessory. Throughout the XR profile creation process, a user may be able to view the effect of the current XR profile, such as by viewing herself through a front-facing camera on her mobile device or seeing a hologram of herself generated by an XR device based on images captured by an external camera device.

At block 2204, process 2200 can receive effect designations for the XR profile created at block 2202. Effect designations can define how to modify an image (e.g., change a user expression, model the user and adjust model features, change a background, etc.), add an overlay (e.g., add clothing, makeup, accessories, an animation, a networking card showing user details, etc.), add an expression construct (e.g., add a thought bubble, status indicator, quote or text), etc. Effects can be attached to anchor point(s) on a user such as to identified points on the user's head, face, or body; or can be positioned relative to the user such as six inches above the user's head. In some cases, effects can be created by the user (e.g., specifying through code or an effect builder what the effect should do and how it is attached to the user). In other cases, effects can be selected from a pre-defined library of effects. In some cases, instead of defining a new XR profile, the user can receive and accept an XR profile created by another user (e.g., through a version of process 2200. This can provide a “photo booth” environment where a set of users have the same trigger/effects applied for shared group viewing.

At block 2206, process 2200 can receive triggers for the XR profile created at block 2202. Triggers can include identifiable events or conditions that can be evaluated with a logical operator. For example, a trigger can be based on who is viewing the XR profile owner, whether a current time is within a specified timeframe, whether an image of the XR profile owner was captured within a given geo-fenced location, whether the user viewing the XR profile owner is within a given geo-fenced location, whether the user viewing the XR profile owner has a particular characteristic (e.g., age, specified interest, home location, occupation, relationship with the XR profile owner, etc.—which can be tracked in a social graph), whether certain environment characteristics are occurring (e.g., nearby object types or places, weather, lighting conditions, traffic, etc.), or any other condition that can be determined by an XR device. In particular, some triggers can be privacy triggers defining users or user types that a viewing user must have for the trigger to be satisfied. For example, the trigger can specify a whitelist of individual users allowed to trigger the XR profile, a blacklist of individual users that cannot trigger the XR profile, or specific relationships to the XR profile owner that a user must have on a social graph (e.g., friends, friends-of-friends, followers, family, or other shared connections). In some cases, a trigger can be for a specified duration (e.g., one hour, one day etc.) or can include another ending trigger, which will cause the XR profile to turn off (stop showing the included effect(s)).

In some cases, a trigger can be an expression, of multiple other triggers, that is satisfied when the entire expression evaluates to true. Thus, a trigger can specify various logical operators, (e.g., AND, OR, XOR, NOT, EQUALS, GTREATER_THAN, LESS_THAN, etc.) between other triggers. For example, the expression could be “(friend_user_within_2_meters AND friend_user_age LESS_THAN 13) OR (number_of_surrounding_users GREATER_THAN 20).” This expression will evaluate to true when either A) a user identified as a friend of the XR profile owner is within two meters of the XR profile owner and that user is less than 13 year old or B) there are at least 20 people in an area defined around the XR profile owner.

Once the effect(s) and trigger(s) for the XR profile are defined, it can be associated with a user's account such that when a system recognizes the user, the XR profile can be checked (using process 2300 below) to determine whether to enable the effect(s) based on the trigger(s). Process 2200 can then end.

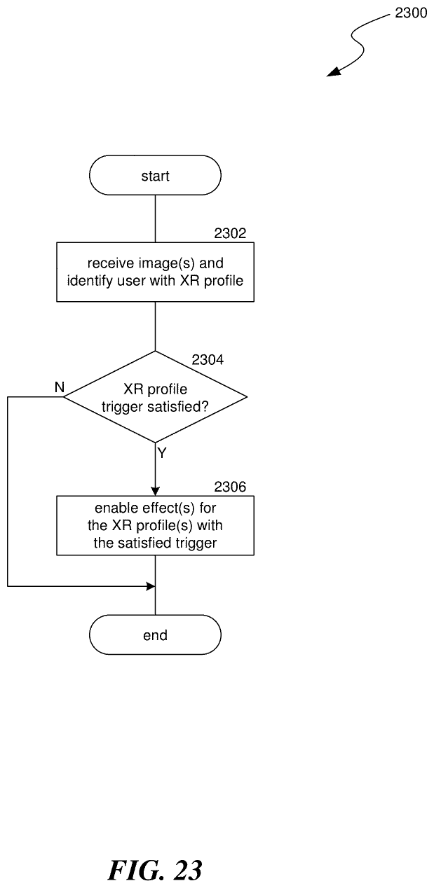

FIG. 23 is a flow diagram illustrating a process 2300 used in some implementations for showing a user with effects specified by an XR profile when trigger conditions for the XR profile are met. In various implementations, process 2300 can be performed on a user device that locally applies XR profiles, on a server system receiving images of users and providing back edited effects, or partially on a server system (e.g., to identify users and provide corresponding XR profiles) and partially on a user device that applies the XR profiles received from the server system. Process 2300 can be initiated as part of another application, such as an AR camera application, an overlay application for an MR device, an image analysis module on a social media platform, etc.

At block 2302, process 2300 can receive one or more images and identify a user with one or more XR profiles. Process 2300 can receive the one or more images from a camera on any type of XR device (VR, AR, or MR); from an image posted to a platform (e.g., as social media post, a video or streaming platform, a news or other media platform, etc.); from another standalone application (e.g., an application for photos, contacts, video); etc. A facial or other user recognition system can then be employed, on the system executing process 2300 or through a call to a third-party system, to recognize users shown in the one or more images. When a user is recognized, process 2300 can determine whether that user has one or more associated XR profiles, e.g., from performing process 2200. When such a user with an XR profile is identified, process 2300 can continue to block 2304.

At block 2304, process 2300 can determine whether the triggers for any of the XR profiles of the user identified at block 2302 are satisfied. As discussed above in relation to block 2206 of FIG. 22, this can include evaluating one or more conditions, which may be in the form of multiple conditions in a compound expression, to determine if the one or more conditions have occurred. In various implementations, determining if a trigger is satisfied includes checking user identifiers or user characteristics against a blacklist or whitelist for privacy conditions; identifying whether the image was captured in a particular geo-fenced area; identifying whether the viewer of the image is in a particular geo-fenced area; determining whether a current time is within a given timeframe; checking environment conditions; etc. In some implementations, the checking of the triggers is performed on a recipient device of the image, so the determination of whether the trigger is satisfied is specific to each recipient user. This allows different XR profiles to be applied to the same set of images for different recipients. For example, in a video call, one recipient for which a trigger of an XR profile is satisfied can see an effect on the sending user, while another user in that same video call for whom the trigger of the XR profile is not satisfied will not see the effect. If a trigger for an XR profile is satisfied at block 2304, process 2300 can continue to block 2306. Otherwise, process 2300 can end.

At block 2306, process 2300 can enable, on the identified user, the effects for the XR profile(s) with the trigger(s) that are satisfied. As discussed above in relation to block 2204 of FIG. 22, effects can modify an image (e.g., change a user expression, model the user and adjust model features, change a background, etc.), add an overlay (e.g., add clothing, makeup, accessories, an animation, a networking card showing user details, etc.), add an expression construct (e.g., add a thought bubble, status indicator, quote or text), etc. Effects can be attached to anchor point(s) on a user such as to identified points on the user's head, face, or body; or can be positioned relative to the user such as eight inches to the left or right of the user's head. As also discussed in relation to examples 1700-2100 above, some classes of effects can include “outfits” where a user can choose from face or body anchored clothing, makeup, accessory, etc. overlays; “statuses” where a user can specify a text, video, or audio message to output in spatial relation to the user; “expressions” where the user can set thought bubbles, animations, or other expressive content in spatial relation to the user; “networking” cards where a user can set information about themselves such as name, business, brand identifier, etc., to hover in spatial relation to the user; or a “photobooth” template where effects can be defined and shared with multiple other users to have a group effect applied to the group of users. After applying the effects for the triggered XR profiles, process 2300 can end.

An external content for 3D environments system (“3DS”) can enable addition of external content to 3D applications. The 3DS can accomplish this by first providing a first interaction process for pre-establishing designated external content areas in a 3D space. For example, an application developer can select a rectangle or cube in an artificial reality environment provided by her 3D application into which external content can be written. The 3DS can also provide a second interaction process, when viewing users are in the artificial reality environment provided by the 3D application, that selects and provides matching external content and allows users to further interact with the external content.

The 3DS can interface with a 3D application controller, such as an application developer, administrator, distributor, etc., to perform the first interaction process, designating areas (i.e., endpoints) in the 3D application in which 3D content can be placed. Such areas can be 2D panels or 3D volumes of various shapes and sizes. These areas can be configured with triggering conditions such as being in view of a user, a viewing user having selected to enable or disable external content, a viewing user having certain characteristics, contextual factors matching a set of conditions, a situation in the 3D application having occurred, etc. In some implementations, these areas can be paired with rules or restrictions on types or characteristics of content that can be written into that area, e.g., subject matter shown, ratings of content that can be shown, sources that can provide external content, etc.

Once established and when a corresponding triggering condition occurs, the 3DS can interface with an external content system to select what content to add to these areas. For example, the 3DS can provide context of the area and/or of the viewing user and the external content system can select matching external content. For example, the external content system can match the area to external content that has a configuration (e.g., size, shape, dimensionality, etc.) that can to be placed in the designated area, that meets any restrictions placed on external content by the 3D application controller, that matches features of the viewing user and/or characteristics of the 3D application, or according to business factors (such as profitability of selections or adherence to external content provider contracts).

In some implementations, when a viewing user selects displayed external content, the 3DS can provide related controls and/or additional information. For example, upon selection, the 3DS can show a standard set of controls, e.g., for the viewing user to save a link to the external content, block the external content, see more details on the external content, see reasons why the external content was selected to be included for the viewing user, etc. In some cases, when a user selects to see additional details, the 3D application can be paused, and a web browser can be displayed directed to a link provided in relation to the external content. For example, if the external content is from a marketing campaign for a brand of footwear, the external content can be associated with a link to a website where the footwear can be acquired.

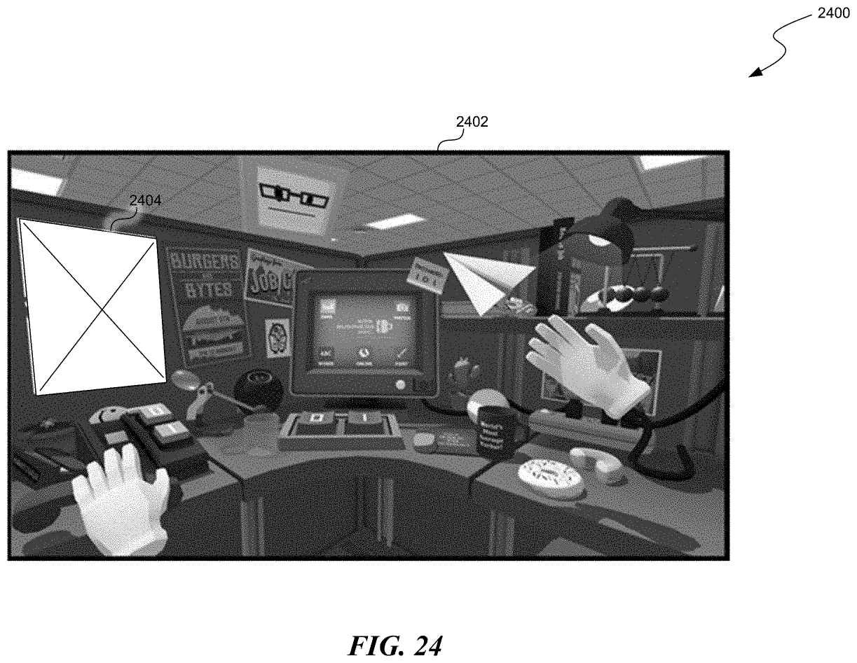

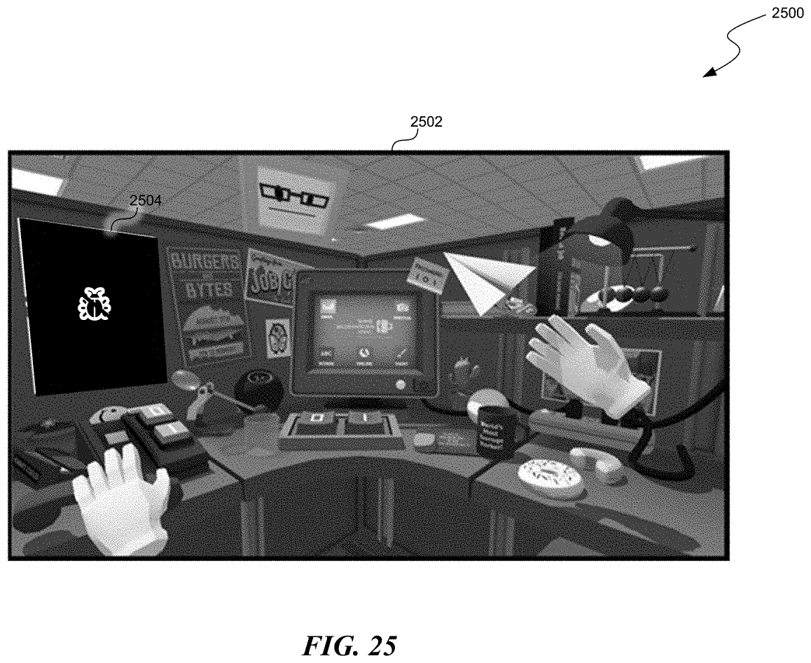

FIG. 24 is an example 2400 of an area 2404 being designated for external content in an artificial reality environment 2402. In example 2400, a 3D application controller (e.g., developer) is viewing an artificial reality environment of her 3D application in an editing interface such as Unity. The developer has selected a tool to specify an external content area, which she has used to draw the flat rectangle area 2404 in the artificial reality environment. This area 2404 is now designated for showing external content. In example 2400, by default the area 2404 is filled with external content upon the trigger of being viewed by a viewing user when using the 3D application. However, the developer has the option of setting other triggers, such as only showing external content in this area once the viewing user has reached level 260 in the 3D application or only showing external content to viewing users who have not paid to exclude external content from their use of the 3D application. FIG. 25 is an example 2500 of a rectangular, 2D designated area 2504 with external content in an artificial reality environment 2502 as viewed by a viewing user. In example 2500, the triggering condition associated with the area 2504 has occurred and external content matching characteristics of the viewing have been selected. This external content has been placed in the area 2504 designated by the 3D application controller and can be selected by the viewing user to save a link to the external content, view additional details, etc.

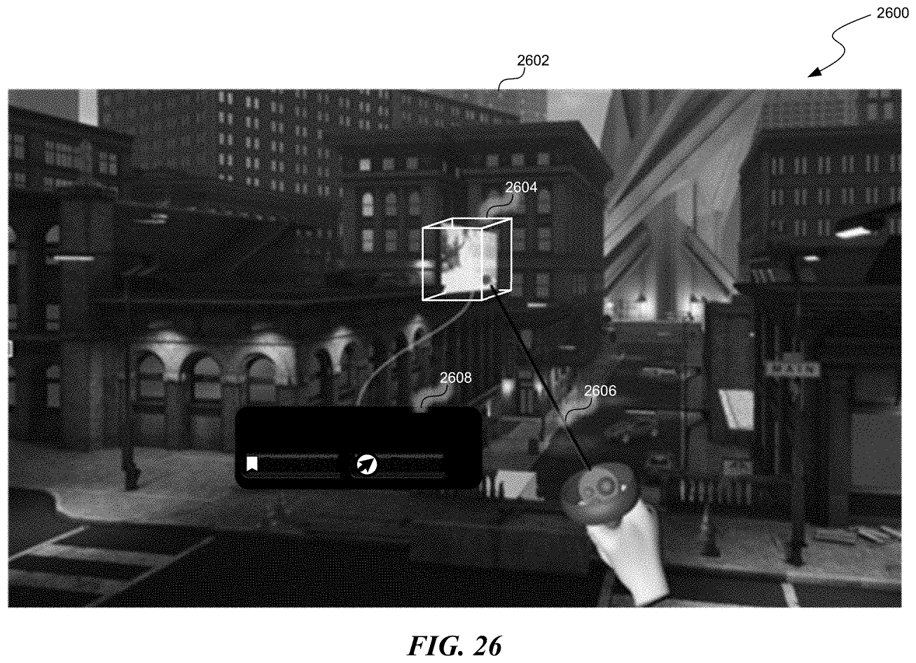

FIG. 26 is an example 2600 of a cuboid 3D designated area 2604 with external content in an artificial reality environment 2602, being selected by a user to show an external content menu 2608. In example 2600, a 3D application controller has previously selected cuboid area 2604 for external content (the actual lines of cuboid 2604 are for illustrative purposes and may not be shown to the viewing user). The viewing user has used a ray 2606 to select the area 2604 and the 3DS, in response, has displayed the external content menu 2608. A provider of the external content has included with the external content a title and a link to more details. The external content menu 2608 provides a template filling in the title and providing controls to save the link or open it in a browser. The external content menu 2608 further includes a more options three-dot control, which the viewing user can access to see additional controls (not shown) such as an option to hide the external content or to see why this external content was selected for her.

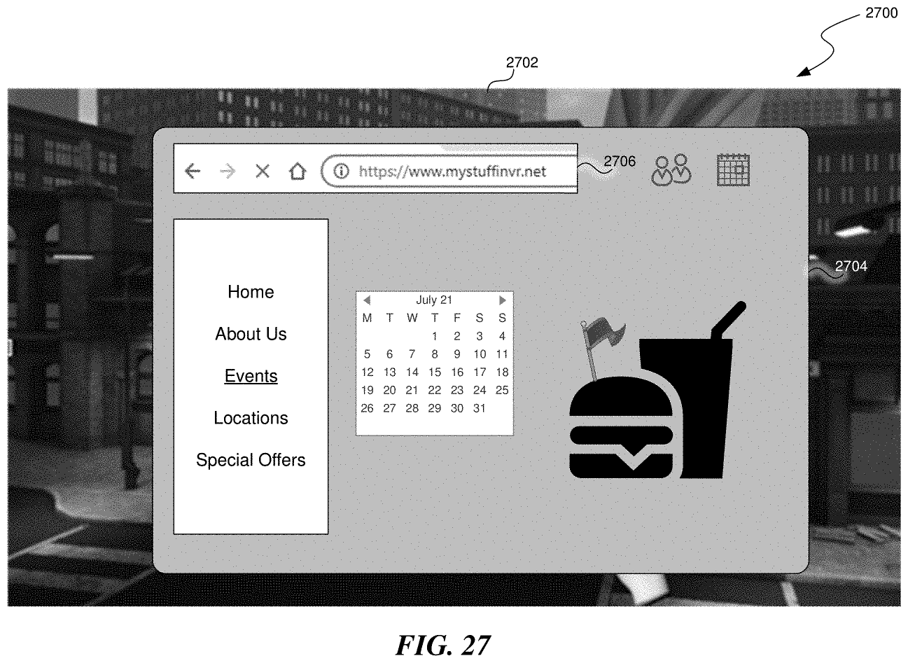

FIG. 27 is an example 2700 of a browser 2704 in an artificial reality environment 2702 overlaid on a paused application showing content related to external content provide in the application. In example 2700, a viewing user has selected a link associated with external content displayed in an artificial reality environment and, in response, the 3DS has brought up web browser 2704, directing it to the address 2706 associated with the selected external content.

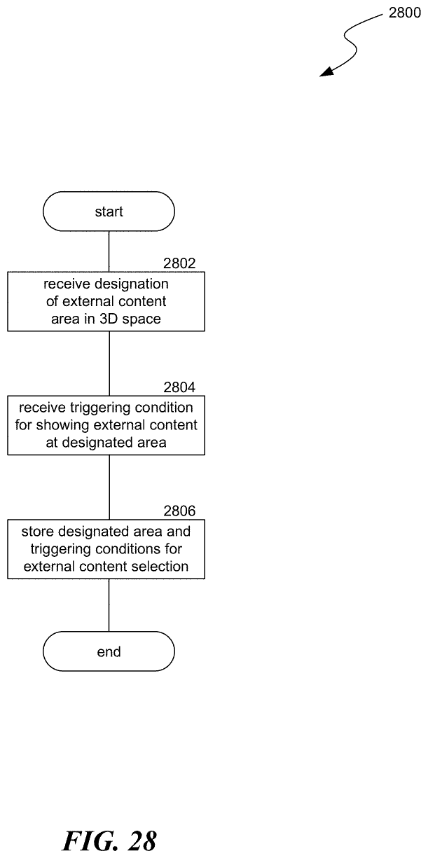

FIG. 28 is a flow diagram illustrating a process 2800 used in some implementations for establishing an external content area in a 3D application. In various implementations, process 2800 can be a client-side process or a server-side process receiving input from a UI on a client. Process 2800 can be initiated when a 3D application controller (e.g., a developer, administrator, distributor, etc.) selects a tool (e.g., a tool configured for designating external content areas) in an application (e.g., Unity or another 3D design or programming application).

At block 2802, process 2800 can receive a designation of an external content area in a 3D space. In various implementations, this designation can be supplied graphically (e.g., with a user manipulating a tool in a 3D design application) or programmatically (e.g., supplying textual coordinates defining the area). In various implementations, the area can be 2D (e.g., a flat or curved 2D panel) or a 3D volume. The area can be various sizes and shapes such as a rectangle, circle, cuboid, or other 2D or 3D shape. In some implementations, an external content system can be configured to provide external content in pre-set configurations, and the 3D application controller can set external content areas corresponding to one of these pre-set configurations. For example, the external content system can provide content in a flat rectangle with a 4:3 ratio of edges, so the tool used by the 3D application controller to select an area can restrict selections to flat rectangles with this edge ratio.

At block 2804, process 2800 can receive designations of one or more triggering conditions for showing external content at the area designated in block 2802 and/or for modifying the area designated at block 2802. In some implementations, the triggering condition can be that the external content is simply baked-in to the artificial reality environment, so the external content is shown whenever the designated area is in view. In other cases, the triggering conditions can define how to modify a size, shape, or position of the area in given circumstances, can specify a context (e.g., condition of the 3D application) in which when area is to include external content, can specify types of content items that may or may not go into area, can specify characteristics of viewing users or viewing user profiles that enable or disable the external content area, etc.

At block 2806, process 2800 can store the designated area and triggering conditions for external content selection. In some implementations, this can include storing the designated area and triggering conditions as variables in the 3D application and/or signaling the designated area and triggering condition to an external content system for pre-selection and/or early delivery of external content to be ready to be displayed in the designated area when the triggering condition occurs. Following block 2806, process 2800 can end.

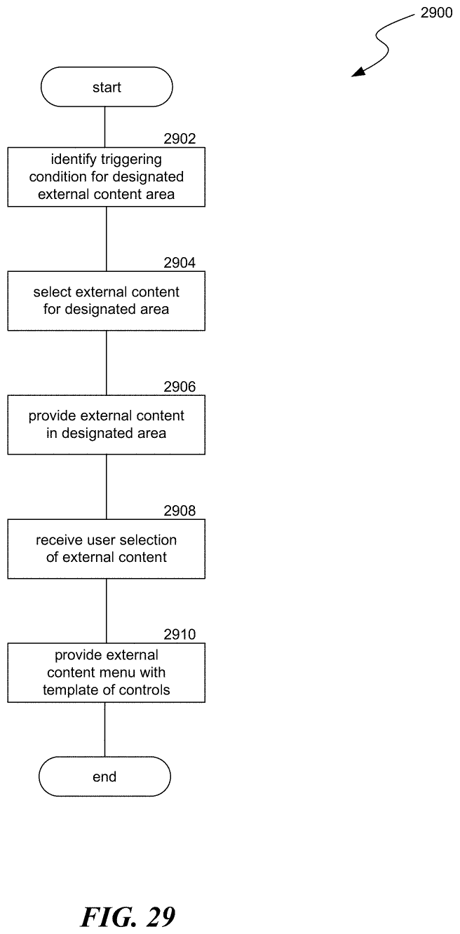

FIG. 29 is a flow diagram illustrating a process 2900 used in some implementations for adding external content to an established area in a 3D application. In various implementations, process 2900 can be a client-side process that identifies triggering conditions and signals to an external content provider for external content to display, or a server-side process receiving indications from a 3D application in relation to triggering conditions and providing external content for the 3D application to display. Process 2900 can be initiated as part of a server application listening for external content requests or when a 3D application, with designated external content areas, is executed on a client.

At block 2902, process 2900 can identify a triggering condition for a designated external content area. In some implementations, the external content can be—preselected for a designated content area and the triggering condition can simply include the external content area coming into view, causing the external content to be viewable. In other cases, the triggering condition can be a set of one or more expressions defined by the 3D application controller (as discussed above in relation to block 2804) that cause external content to be viewable when the set of expressions evaluate to true. In some implementations, evaluating the triggering conditions occurs after the external content is selected at block 2904. For example, content can be pre-selected for a designated area, and the triggering conditions can be evaluated as the 3D application executes to determine whether the external content should be made viewable.

At block 2904, process 2900 can select external content for the designated area. In some cases, the selection of external content can include matching of size/shape of the designated area to that of the external content. For example, only 3D designated areas can have 3D models selected for them or a flat piece of external content may have a particular shape or edge dimensions that a designated area must meet. In some cases, the external content selection can be limited by content subject matter, objects, ratings, etc. set by the 3D application controller. In some implementations, external content can be ranked according to how closely it matches features of the artificial reality environment of the 3D application (e.g., matching theme or subject matter), how closely it matches characteristics of a viewing user (e.g., how likely the viewing user is to want to see the external content or engage with it), or based on how much it promotes business factors (e.g., profitability, promotions offered to content providers, guaranteed views, etc.), and only the highest ranking external content is selected.

At block 2906, process 2900 can cause the selected external content to be displayed in the designated area. This can include providing the external content to the 3D application (e.g., from a remote source) for the application to include in the designated area or a local module displaying the external content in the designated area.

At block 2908, process 2900 can receive a viewing user selection of the external content. For example, this can include the viewing user pointing a ray at the designated area, picking up an object including the designated area, performing a gesture (e.g., an air tap) in relation to the designated area, providing a voice command indicating the external content, etc.

In response to the viewing user selection, at block 2910, process 2900 can provide an external content menu with a templated set of controls in relation to the external content. In various implementations, the external content menu can include one or more of: a control to save a link to the external content, a control to access additional details for the external content, a control to open a link related to the external content, a control to learn why the external content was selected, a control to report the external content as inappropriate, or a control to hide the external content and/or similar external content for this viewing user. The control to save the link to the external content can store the link in a user-specific repository that the viewing user can later visit to review the external content. The control to access the additional details for the external content can cause additional details, provided with the external content, such as an extended description, information on the external content source, special offers, etc. to be displayed. The control to open the link related to the external content can cause the 3D application to close or pause and can bring up a web browser that is automatically directed to the link provided in relation to the external content. The control to learn why the external content was selected can provide details on the matching conditions used at block 2904 to select the external content. The control to report the external content as inappropriate can send a notification to an external content provider to review the content or aggregate the report with similar reports provided by others. The control to hide the external content and/or similar external content for this viewing user can cause the external content to be removed and/or replaced with other external content or this control can change the selection criteria used by block 2904 to reduce the ranking of similar content for future external content selections. In some cases, the externa content menu can be displayed until a timer (e.g., set for 2600 milliseconds) expires, but this timer can reset while the user is focused on or interacts with aspects of the external content menu. Following block 2910, process 2900 can end.

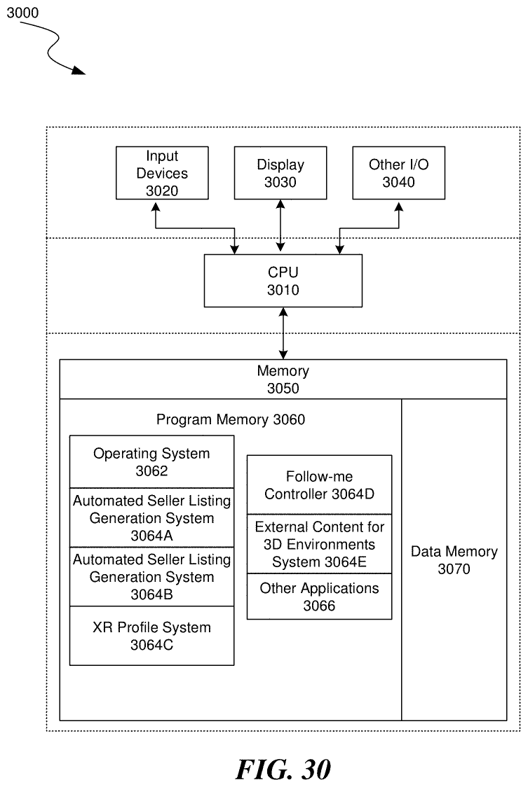

FIG. 30 is a block diagram illustrating an overview of devices on which some implementations of the disclosed technology can operate. In some implementations, the devices can comprise hardware components of a device 3000 that can automatically generate seller listing titles and descriptions for products. In some implementations, the devices can comprise hardware components of a device 3000 that can set a follow-me mode for various virtual objects, causing the virtual objects to be displayed as word-locked or body-locked in response to a current mode for the virtual objects and the location of the user of the XR device in relation to various anchor points for the virtual objects. In some implementations, the devices can comprise hardware components of a device 3000 that can create and/or apply XR profiles that specify one or more triggers for one or more effects that are applied to a user when the triggers are satisfied. In some implementations, the devices can comprise hardware components of a device 3000 that can enable addition of external content in 3D applications. Device 3000 can include one or more input devices 3020 that provide input to the Processor(s) 3010 (e.g., CPU(s), GPU(s), HPU(s), etc.), notifying it of actions. The actions can be mediated by a hardware controller that interprets the signals received from the input device and communicates the information to the processors 3010 using a communication protocol. Input devices 3020 include, for example, a mouse, a keyboard, a touchscreen, an infrared sensor, a touchpad, a wearable input device, a camera- or image-based input device, a microphone, or other user input devices.

Processors 3010 can be a single processing unit or multiple processing units in a device or distributed across multiple devices. Processors 3010 can be coupled to other hardware devices, for example, with the use of a bus, such as a PCI bus or SCSI bus. The processors 3010 can communicate with a hardware controller for devices, such as for a display 3030. Display 3030 can be used to display text and graphics. In some implementations, display 3030 provides graphical and textual visual feedback to a user. In some implementations, display 3030 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 3040 can also be coupled to the processor, such as a network card, video card, audio card, USB, firewire or other external device, camera, printer, speakers, CD-ROM drive, DVD drive, disk drive, or Blu-Ray device.

In some implementations, the device 3000 also includes a communication device capable of communicating wirelessly or wire-based with a network node. The communication device can communicate with another device or a server through a network using, for example, TCP/IP protocols. Device 3000 can utilize the communication device to distribute operations across multiple network devices.

The processors 3010 can have access to a memory 3050 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 3050 can include program memory 3060 that stores programs and software, such as an operating system 3062, Automated Seller Listing Generation Systems 3064A and 3064B, XR Profile System 3064C, Follow-me Controller 3064D, External Content for 3D Environments System 3064E, and other application programs 3066. Memory 3050 can also include data memory 3070, configuration data, settings, user options or preferences, etc., which can be provided to the program memory 3060 or any element of the device 3000.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

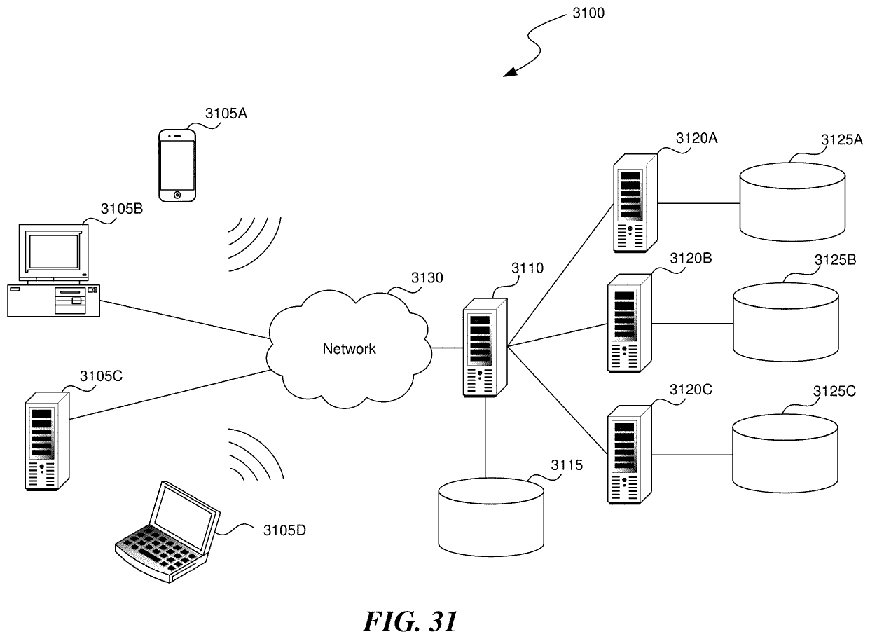

FIG. 31 is a block diagram illustrating an overview of an environment 3100 in which some implementations of the disclosed technology can operate. Environment 3100 can include one or more client computing devices 3105A-D, examples of which can include device 3000. Client computing devices 3105 can operate in a networked environment using logical connections through network 3130 to one or more remote computers, such as a server computing device.

In some implementations, server 3110 can be an edge server which receives client requests and coordinates fulfillment of those requests through other servers, such as servers 3120A-C. Server computing devices 3110 and 3120 can comprise computing systems, such as device 3000. Though each server computing device 3110 and 3120 is displayed logically as a single server, server computing devices can each be a distributed computing environment encompassing multiple computing devices located at the same or at geographically disparate physical locations. In some implementations, each server 3120 corresponds to a group of servers.

Client computing devices 3105 and server computing devices 3110 and 3120 can each act as a server or client to other server/client devices. Server 3110 can connect to a database 3115. Servers 3120A-C can each connect to a corresponding database 3125A-C. As discussed above, each server 3120 can correspond to a group of servers, and each of these servers can share a database or can have their own database. Databases 3115 and 3125 can warehouse (e.g., store) information. Though databases 3115 and 3125 are displayed logically as single units, databases 3115 and 3125 can each be a distributed computing environment encompassing multiple computing devices, can be located within their corresponding server, or can be located at the same or at geographically disparate physical locations.

Network 3130 can be a local area network (LAN) or a wide area network (WAN), but can also be other wired or wireless networks. Network 3130 may be the Internet or some other public or private network. Client computing devices 3105 can be connected to network 3130 through a network interface, such as by wired or wireless communication. While the connections between server 3110 and servers 3120 are shown as separate connections, these connections can be any kind of local, wide area, wired, or wireless network, including network 3130 or a separate public or private network.

In some implementations, servers 3110 and 3120 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (e.g., via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

The disclosed technology can include, for example, the following:

A method for switching a virtual object between world-locked and body-locked modes, the method comprising, in response to determining that the virtual object is in a particular mode: identifying an anchor point, mapped to the virtual object, in a room occupied by an artificial reality device; in response to the identifying the anchor point, displaying the virtual object as locked to the anchor point; identifying a transition including identifying that the artificial reality device has moved a threshold distance away from the anchor point or out of the room; and in response to the identifying the transition, displaying the virtual object as locked relative to a position of the artificial reality device.

A computer-readable storage medium storing instructions that, when executed by a computing system, cause the computing system to perform a process for switching a virtual object between world-locked and body-locked modes, as shown and described herein.

A computing system for presenting a virtual object in world-locked and body-locked modes, as shown and described herein.

A method for providing a predicted n-gram for a product listing, the method comprising: receiving a listing context including user input; predicting a product type based on the listing context; predicting an attribute value based on the listing context and the predicted product type; and providing the predicted product type and/or attribute value as a suggestion for inclusion in the product listing.

A method for providing product listing creation suggestions, the method comprising: receiving a product image; predicting a product label based on the product image; predicting one or more product attributes based on the product image and the product label; applying a fusion model to: select nodes, in a hierarchy, corresponding to the predicted one or more product attributes; and identify suggested product descriptions in one or more product description tables, the one or more product description tables corresponding to the selected nodes in the hierarchy; and providing the suggested product descriptions as a suggestion for creating the product listing.

A computing system comprising one or more processors and one or more memories storing instructions that, when executed by the one or more processors, cause the computing system to perform a process as shown and described herein.

A computer-readable storage medium storing instructions that, when executed by a computing system, cause the computing system to perform a process as shown and described herein.

A method for applying an effect defined in an XR profile, the method comprising: receiving one or more images and identifying a user depicted in the one or more images that has a defined XR profile; determining that a current context satisfies a trigger for the defined XR profile; and in response to the determining, enabling one or more effects from the XR profile in relation to the identified user.

A method for establishing an external content area in a 3D application, the method comprising: receiving a designation of an external content area in a 3D space; determining a triggering condition for showing external content in the designated external content area; and storing the designated area and triggering condition for external content selection.

A computer-readable storage medium storing instructions that, when executed by a computing system, cause the computing system to perform a process comprising: identifying a triggering condition for a designated external content area; selecting external content matching the external content area; and in response to the identified triggering condition, causing the selected external content to be displayed in the designated external content area.

The previous computer-readable storage medium, wherein the process further comprises receiving a viewing user selection in relation to the provided external content; and in response to the viewing user selection, causing an external content menu to be displayed in relation to the displayed external content.

The previous computer-readable storage medium, wherein the process further comprises receiving a second viewing user selection, in the external content menu, in relation to a link associated with the external content; and in response to the second viewing user selection, causing a web browser to be displayed that is automatically directed to the link.

I/We claim:

1. A method for establishing an external content area in a 3D application, the method comprising:
receiving a designation of an external content area in a 3D space;
determining a triggering condition for showing external content in the designated external content area; and
storing the designated area and triggering condition for external content selection.

2. A system as shown and described herein.

3. A computer-readable storage medium storing instructions that, when executed by a computing system, cause the computing system to perform a process comprising:
identifying a triggering condition for a designated external content area;
selecting external content matching the external content area; and
in response to the identified triggering condition, causing the selected external content to be displayed in the designated external content area.

4. The computer-readable storage medium of claim 3, wherein the process further comprises
receiving a viewing user selection in relation to the provided external content; and
in response to the viewing user selection, causing an external content menu to be displayed in relation to the displayed external content.

5. The computer-readable storage medium of claim 4, wherein the process further comprises
receiving a second viewing user selection, in the external content menu, in relation to a link associated with the external content; and
in response to the second viewing user selection, causing a web browser to be displayed that is automatically directed to the link.
